(19) United States
(12) Patent Application Publication
(10) Pub. No.: US 2024/0121868 A1
(43) Pub. Date: Apr. 11, 2024

(54) MICROWAVE PROCESSING DEVICE

(71) Applicant: Panasonic Intellectual Property Management Co., Ltd., Osaka (JP)

(72) Inventors: DAISUKE HOSOKAWA, Shiga (JP); YOSHIHARU OOMORI, Shiga (JP); HIDEKI NAKAMURA, Kyoto (JP); KAZUKI MAEDA, Shiga (JP); TAKASHI UNO, Shiga (JP)

(21) Appl. No.: 18/262,569

(22) PCT Filed: Jan. 24, 2022
(86) PCT No.: PCT/JP2022/002317

§ 371 Date: Jul. 22, 2023

(30) Foreign Application Priority Data
Jan. 29, 2021 (JP) 2021-012567

(51) Int. Cl. H05B 6/64; H05B 6/68; H05B 6/80

(52) U.S. Cl. CPC H05B 6/6447; H05B 6/686; H05B 6/802

(57) ABSTRACT

A microwave processing device of the present disclosure is provided with a heating chamber, a microwave generating unit, an amplifying unit, a power supply unit, a detecting unit, a control unit, and a storage unit. The microwave generating unit generates microwave having an optional frequency in a predetermined frequency band. The amplifying unit amplifies an output level of the microwave. The power supply unit radiates the microwave amplified by the amplifying unit into the heating chamber as incident electric power. The detecting unit detects reflected electric power, which returns to the power supply unit from the heating chamber, from among the incident electric power. The control unit controls the microwave generating unit and the amplifying unit. The storage unit stores a value of the reflected electric power, together with a frequency of the microwave and an elapsed time from the start of heating. The control unit controls the microwave generating unit and the amplifying unit based on a calculated value obtained by calculation with reference to the reflected electric power.

### TECHNICAL FIELD

The present disclosure relates to a microwave processing device provided with a microwave generating unit.

### BACKGROUND ART

In the conventional microwave processing device, some device detects boiling of a heating target based on a change over time in an amount of reflected wave, thereby changing an oscillation frequency, an oscillation output, and the like of a semiconductor oscillator (e.g., see Patent Literature 1).

The boiling of a heating target is detected based on a total sum of reflected microwave power or a magnitude of change in a ratio of the total sum of reflected microwave power to a total sum of incident microwave power. An absolute value, a deviation, and a standard deviation are used as an index indicating the magnitude of change. At the time when the boiling is detected, the conventional microwave processing device, mentioned above, stops heating or reduces heating output. Thus, it is intended to control the temperature of food with sufficient accuracy.

### CITATION LIST

### Patent Literature

PTL1: International Publication No. 2018/125147

### Non-Patent Literature

NPL1: Kenji Yamanishi, Abnormality detection by data mining, Kyoritsu shuppan, 2009
NPL2: J. Takeuchi and K. Yamanishi. A Unifying framework for detecting outliers and change points from time series. IEEE. Transaction on Knowledge and Data Engineering, 18(4):482-492, 2006.
NPL3: K. Yamanishi and J. Takeuchi. Discovering outlier filtering rules from unlabeled data. In Proceeding of the Seventh ACM SIGKDD International Conference on Knowledge Discovery and Data Mining (KDD01), ACM Press, pp. 389-394, 2001

### SUMMARY OF THE INVENTION

However, in the microwave processing device described in Patent Literature 1, there is still room for improvement in respect of accuracy of the boiling control. Accordingly, the present disclosure aims to provide a microwave processing device capable of detecting a change in state of a heating target with sufficient accuracy.

A microwave processing device in accordance with an aspect of the present disclosure is provided with a heating chamber that accommodates a heating target, a heating unit that includes a microwave generating unit, an amplifying unit, a power supply unit, a detecting unit, a control unit, and a storage unit.

The microwave generating unit generates microwave having an optional frequency in a predetermined frequency band. The amplifying unit amplifies an output level of the microwave. The power supply unit radiates the microwave amplified by the amplifying unit into the heating chamber as incident electric power. The detecting unit detects reflected electric power, which returns to the power supply unit from the heating chamber, from among the incident electric power.

The control unit controls the microwave generating unit and the amplifying unit. The storage unit stores a value of the reflected electric power, together with a frequency of the microwave and an elapsed time from the start of heating. The control unit controls the microwave generating unit and the amplifying unit based on a calculated value obtained by calculation with reference to the reflected electric power.

The microwave processing device in accordance with the present disclosure can detect a change in state of a heating target with sufficient accuracy. The change in state of a heating target includes boiling, expansion, melting, defrosting, a burst, drying, and the like, i.e., a change in dielectric constant of the heating target due to heating and changes in shape and state of the heating target due to heating.

### BRIEF DESCRIPTION OF DRAWINGS

FIG. 1 is a schematic configuration diagram of a microwave processing device in accordance with a first exemplary embodiment of the present disclosure.

FIG. 2 is a flowchart showing a flow of the entire cooking control in the first exemplary embodiment.

FIG. 3 is a flowchart showing details of detection processing of reflected electric power in the first exemplary embodiment.

FIG. 4 is a flowchart showing a flow of calculating a score in a change finder (change finder).

FIG. 5 is a view for explaining a threshold that is used for detecting a change in state of a heating target in the first exemplary embodiment.

FIG. 6 is a view for explaining detection of the change in state of a heating target in the first exemplary embodiment.

FIG. 7 is a conceptual diagram showing boiling detection of a heating target in the first exemplary embodiment.

FIG. 8A is a view showing heating conditions in a demonstration experiment of the boiling detection in the first exemplary embodiment.

FIG. 8B is a first view showing experimental results of the boiling detection in the first exemplary embodiment.

FIG. 8C is a second view showing experimental results of the boiling detection in the first exemplary embodiment.

FIG. 8D is a third view showing experimental results of the boiling detection in the first exemplary embodiment.

FIG. 8E is a fourth view showing experimental results of the boiling detection in the first exemplary embodiment.

FIG. 9 is a flowchart showing a flow of the entire cooking control in a second exemplary embodiment.

FIG. 10 is a flowchart showing details of detection processing of reflected electric power in the second exemplary embodiment.

FIG. 11 is a view for explaining detection of a change in state of a heating target in the second exemplary embodiment.

FIG. 12 is a conceptual diagram showing expansion detection of a heating target in the second exemplary embodiment.

FIG. 13 is a view for explaining detection of a change in state of a heating target in a third exemplary embodiment.

FIG. 14 is a conceptual diagram showing melting detection of a heating target in the third exemplary embodiment.

FIG. 15A is a view for explaining heating conditions in a demonstration experiment of the melting detection in the third exemplary embodiment.

FIG. 15B is a first view showing experimental results of the melting detection in the third exemplary embodiment.

FIG. 15C is a second view showing experimental results of the melting detection in the third exemplary embodiment.

FIG. 16 is a conceptual diagram showing defrosting detection of a heating target in a fourth exemplary embodiment.

FIG. 17 is a conceptual diagram showing burst detection of a heating target in a fifth exemplary embodiment.

FIG. 18 is a conceptual diagram showing drying detection of a heating target in a sixth exemplary embodiment.

### DESCRIPTION OF EMBODIMENTS

(Knowledge Used as Foundation of Present Disclosure)

The microwave processing device described in Patent Literature 1 detects a boiling state of a heating target from a change in reflected electric power or a change in ratio of a total sum of reflected electric power to a total sum of incident electric power. Hereinafter, the ratio of a total sum of reflected electric power to a total sum of incident electric power is referred to as reflectance.

However, it will be difficult to detect a change in state of a heating target with sufficient accuracy, unless frequency characteristics of microwave are taken into account. A degree of change in reflected electric power with respect to a change in state of a heating target is different depending on the frequency.

For instance, a change in reflected electric power with respect to the boiling of a liquid becomes large at one frequency, but small at another frequency. Such frequency characteristics depend on a standing wave distribution of microwave in a heating chamber. Therefore, the frequency characteristics are significantly affected by a kind, viscosity, quantity, and a shape of a heating target, a placing position thereof, a shape of a heating chamber, and the like. The frequency characteristics are also affected by a kind of change in state of a heating target, such as expansion, melting, defrosting, a burst, and drying.

Accordingly, when various kinds of heating targets are cooked actually, it will be difficult to detect the change in state thereof using one frequency or a narrow-band frequency.

As a result of extensive studies, the inventors of the present application have reached the following invention: a change in state of a heating target can be detected with sufficient accuracy based on a change in reflected electric power in which the frequency characteristics are taken into account.

A microwave processing device in accordance with a first aspect of the present disclosure is provided with a heating chamber that accommodates a heating target, a heating unit that includes a microwave generating unit, an amplifying unit, a power supply unit, a detecting unit, a control unit, and a storage unit.

The microwave generating unit generates microwave having an optional frequency in a predetermined frequency band. The amplifying unit amplifies an output level of microwave. The power supply unit radiates the microwave, which is amplified by the amplifying unit, into the heating chamber as incident electric power. The detecting unit detects reflected electric power, which returns to the power supply unit from the heating chamber, from among the incident electric power.

The control unit controls the microwave generating unit and the amplifying unit. The storage unit stores a value of the reflected electric power, together with a frequency of the microwave and an elapsed time from the start of heating. The control unit controls the microwave generating unit and the amplifying unit based on a calculated value obtained by calculation with reference to the reflected electric power.

In a microwave processing device in accordance with a second aspect of the present disclosure, the control unit may use an average of values calculated for every frequency of the microwave as a calculated value, in addition to the first aspect. The average of values calculated for every frequency is, for example, an average of values of the reflected electric power that are calculated for every frequency.

In a microwave processing device in accordance with a third aspect of the present disclosure, the control unit may calculate a calculated value for every frequency of the microwave, in addition to the first aspect. When calculated values for two or more frequencies of the microwave exceed a threshold, the control unit may control the microwave generating unit.

In a microwave processing device in accordance with a fourth aspect of the present disclosure, in any of the first aspect to the third aspect, the control unit may calculate a calculated value using a change finder serving as an online change-point detection method for time series data.

In a microwave processing device of a fifth aspect of the present disclosure, the detecting unit may further detect incident electric power. The storage unit may store a value of the incident electric power, together with the frequency of the microwave and the elapsed time. The control unit may calculate reflectance, which is a ratio of a total sum of the reflected electric power to a total sum of the incident electric power, as a calculated value. The control unit may control the microwave generating unit based on the reflectance.

In a microwave processing device in accordance with a sixth aspect of the present disclosure, the storage unit may store a calculated value together with the elapsed time, in addition to the first aspect. When the calculated value exceeds a threshold that is more than one time and less than three times of the minimum of the calculated value stored in the storage unit, the control unit may control the microwave generating unit.

In a microwave processing device in accordance with a seventh aspect of the present disclosure, in addition to the sixth aspect, the control unit may not control the microwave generating unit until a predetermined time has elapsed from the start of heating, even if the calculated value exceeds the above-mentioned threshold.

In a microwave processing device in accordance with an eighth aspect of the present disclosure, when the calculated value exceeds the above-mentioned threshold a plurality of times within a predetermined period of time, the control unit may control the microwave generating unit, in addition to the sixth aspect.

In a microwave processing device in accordance with a ninth aspect of the present disclosure, when the calculated value exceeds the above-mentioned threshold continuously within a predetermined period of time, the control unit may control the microwave generating unit, in addition to the sixth aspect.

In a microwave processing device in accordance with a tenth aspect of the present disclosure, the control unit detects boiling of a heating target as a change in state of the heating target, in addition to any of the first aspect to the ninth aspect.

In a microwave processing device in accordance with an eleventh aspect of the present disclosure, the control unit detects expansion of a heating target as a change in state of the heating target, in addition to any of the first aspect to the ninth aspect.

In a microwave processing device in accordance with a twelfth aspect of the present disclosure, the control unit detects melting of a heating target as a change in state of the heating target, in addition to any of the first aspect to the ninth aspect.

In a microwave processing device in accordance with the thirteenth aspect of the present disclosure, the control unit detects defrosting of a heating target as a change in state of the heating target, in addition to any of the first aspect to the ninth aspect.

In a microwave processing device of a fourteenth aspect of the present disclosure, the control unit detects a burst of a heating target as a change in state of the heating target, in addition to any of the first aspect to the ninth aspect.

In a microwave processing device of a fifteenth aspect of the present disclosure, the control unit detects drying of a heating target as a change in state of the heating target, in addition to any of the first aspect to the ninth aspect.

In a microwave processing device of a sixteenth aspect of the present disclosure, the control unit may stop heating after the change in state of the heating target is detected, in addition to any of the tenth aspect to the fifteenth aspect.

In a microwave processing device in accordance with a seventeenth aspect of the present disclosure, the control unit may change heating conditions in the heating unit after the change in state of the heating target is detected.

Hereinafter, exemplary embodiments of the present disclosure will be described with reference to the attached drawings.

### First Exemplary Embodiment

<Entire Configuration>

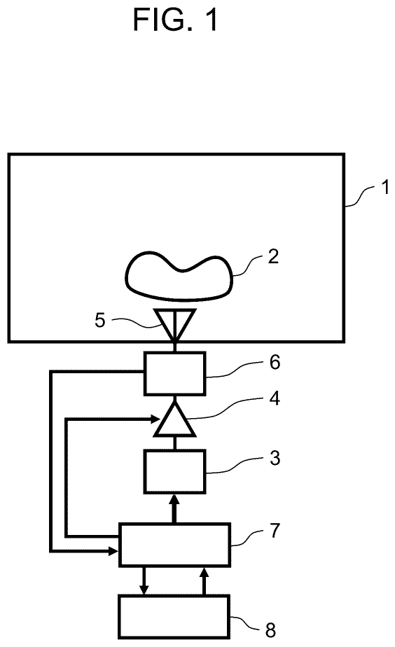

FIG. 1 is a schematic configuration diagram of a microwave processing device in accordance with a first exemplary embodiment of the present disclosure. As shown in FIG. 1, the microwave processing device in accordance with the first exemplary embodiment is provided with heating chamber 1, microwave generating unit 3, amplifying unit 4, power supply unit 5, detecting unit 6, control unit 7, and storage unit 8. In the first exemplary embodiment, microwave generating unit 3 corresponds to a heating unit.

Heating chamber 1 accommodates heating target 2 such as a food serving as a load. Microwave generating unit 3 is constituted by a semiconductor element. Microwave generating unit 3, which can generate microwave having an optional frequency in a predetermined frequency band, generates microwave having the frequency specified by control unit 7.

Amplifying unit 4 is constituted by a semiconductor element. According to instructions of control unit 7, amplifying unit 4 amplifies an output level of the microwave, which is generated by microwave generating unit 3, and outputs the amplified microwave.

Power supply unit 5, which functions as an antenna, supplies the microwave amplified by the amplifying unit 4 to heating chamber 1 as incident electric power. In other words, power supply unit 5 supplies the incident electric power, which is based on the microwave generated by microwave generating unit 3, to heating chamber 1. Among the incident electric power, unconsumed power by heating target 2 or the like returns to power supply unit 5 from heating chamber 1 as reflected electric power.

Detecting unit 6 is constituted by a directional coupler, for example. Detecting unit 6 detects a value of the incident electric power and a value of the reflected electric power, and notifies control unit 7 of information related to the values. In other words, detecting unit 6 functions as both an incident-electric-power detecting unit and a reflected-electric-power detecting unit.

Detecting unit 6 has a coupling degree of approximately −40 dB, for example, and extracts electric power equivalent to substantially 1/10000 of the incident electric power and the reflected electric power. The extracted incident electric power is rectified by a detection diode (not shown), smoothed by a capacitor (not shown), and converted into information corresponding to the incident electric power. Similarly, the extracted reflected electric power is converted into information corresponding to the reflected electric power through the rectification and the smoothing. Control unit 7 receives these pieces of information.

Storage unit 8, which is a storage medium such as a semiconductor memory, stores data from control unit 7. Storage unit 8 reads out the stored data and transmits it to control unit 7. Control unit 7 is constituted by a microprocessor including a CPU (central processing unit). Based on the information from detecting unit 6 and storage unit 8, control unit 7 controls microwave generating unit 3 and amplifying unit 4 to perform cooking control in the microwave processing device.

Control unit 7 causes storage unit 8 (a first storage part of storage unit 8) to store a value of the reflected electric power, together with a frequency of the microwave, which is generated by the microwave generating unit 3, and an elapsed time from the start of heating.

The control unit 7 performs calculation with reference to the value of the reflected electric power stored in storage unit 8 to control microwave generating unit 3 based on calculated value RF that is obtained above. Control unit 7 causes storage unit 8 (a second storage part of storage unit 8) to store calculated value RF. Calculated value RF is a value indicating a change amount of reflected electric power, for example. The value, which indicates the change amount of reflected electric power, will be described later.

As calculated value RF, control unit 7 employs an average of values calculated for every frequency of the microwave. The average of values calculated for every frequency is an average of values of the reflected electric power calculated for every frequency, for example.

As calculated value RF, control unit 7 employs a value calculated by using a change finder. The change finder is an online change-point detection method for time series data.

Control unit 7 causes storage unit 8 (the second storage part of storage unit 8) to store calculated value RF together with an elapsed time from the start of heating. When calculated value RF exceeds threshold TH, control unit 7 controls microwave generating unit 3 to adjust the microwave power. Threshold TH is a value more than one time and less than three times of the minimum of calculated value RF.

Even if calculated value RF exceeds threshold TH, control unit 7 does not control microwave generating unit 3 until a predetermined time has elapsed from the start of heating.

Storage unit 8, which is a single semiconductor memory, includes the first storage part and the second storage part. However, the first storage part and the second storage part may be constituted by separate semiconductor memories, individually.

In the first exemplary embodiment, control unit 7 performs boiling detection of heating target 2 in heating chamber 1. Control unit 7 causes microwave generating unit 3 to stop generating microwave after the boiling is detected.

<Flowchart>

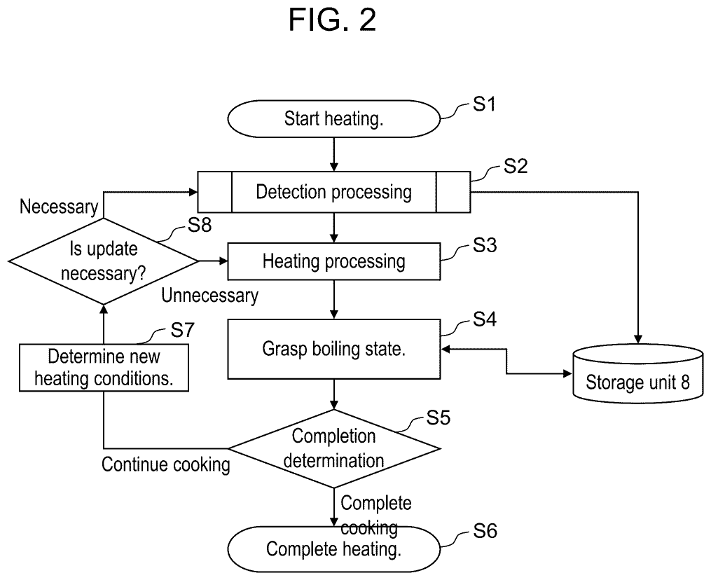

FIG. 2 is a flowchart showing a flow of the entire cooking control in the first exemplary embodiment. As shown in FIG. 2, when control unit 7 causes microwave generating unit 3 to generate microwave to start heating (step S1), control unit 7 performs detection processing (step S2) of reflected electric power, firstly.

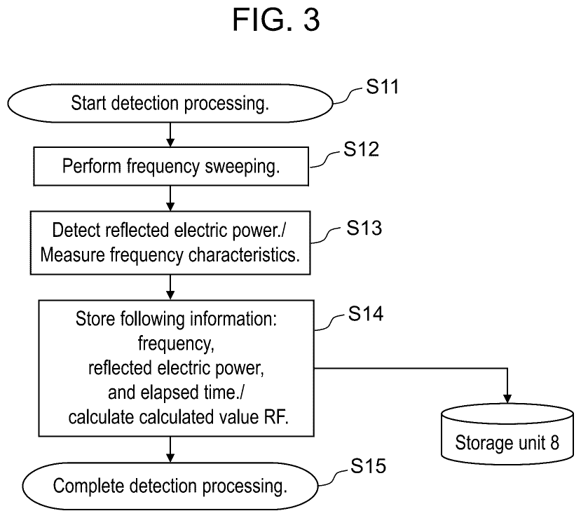

FIG. 3 is a flowchart showing details of the detection processing. As shown in FIG. 3, when the detection processing is started (step S11), microwave generating unit 3 performs frequency sweeping (step S12). The frequency sweeping is an operation of microwave generating unit 3 in which frequency is sequentially changed at predetermined frequency intervals over a predetermined frequency band (e.g., 2400 MHz to 2500 MHz).

Detecting unit 6 detects reflected electric power for each frequency of the microwave during the frequency sweeping. Control unit 7 measures frequency characteristics of reflected electric power from the reflected electric power detected above (step S13).

Control unit 7 causes storage unit 8 (the first storage part of storage unit 8) to store each frequency in the frequency sweeping, a value of the reflected electric power for each frequency obtained in the measurement processing, and an elapsed time from the start of heating (step S14). Based on the frequency characteristics of the obtained reflected electric power, control unit 7 calculates calculated value RF (step S14), which is used for detecting the boiling, and completes the detection processing (step S15).

Returning the processing to the flowchart shown in FIG. 2, control unit 7 heats heating target 2 by microwave heating in heating processing (step S3).

Control unit 7 grasps a boiling state of heating target 2 from the information obtained in the detection processing (step S4). In completion determination (step S5), control unit 7 determines whether heating target 2 is in the boiling state or not.

When determining that heating target 2 is in the boiling state, control unit 7 completes the cooking (step S6). If not, control unit 7 will continue the cooking, i.e., determine new heating conditions as necessary (step S7) and proceed the processing to step S8.

In step S8, when a certain period of time has elapsed from the start of heating, or when the heating conditions are changed or the like, control unit 7 determines whether an update of frequency characteristics is necessary or not. If the update is necessary, control unit 7 will return the processing to the detection processing (step S2). If not necessary, control unit 7 will return the processing to the heating processing (step S3).

<Change Finder>

A change finder is a method of calculating a score, which indicates a degree of change in time series data, in real time. The representative literature related to the change finder is Non-patent Literatures 1 to 3.

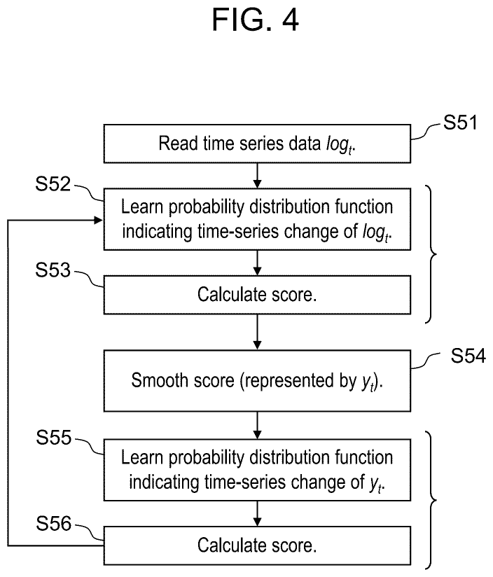

Herein, the summary of a change finder will be described. FIG. 4 is a flowchart showing a flow of calculating a score in the change finder. In the change finder, a method based on two-step learning of a time series model is employed, and the processing thereof is roughly divided into steps S51 through S56.

As shown in FIG. 4, time series data are read in step S51. The time series data in the present disclosure include a frequency of the microwave, an elapsed time from the start of heating, incident electric power, reflected electric power, and reflectance.

In step S52, a probability distribution function is learned. In step S53, a score is calculated. The processes of steps S52 and S53 are collectively referred to as first-step learning. An AR model (autoregressive model), which is a stochastic model of time series data, is learned using an online forgetting type learning algorithm (hereafter, referred to as an SDAR (sequentially discounting AR learning) algorithm). From the obtained probability density function, outliers in data at each point of time are calculated using a logarithm loss or a Hellinger score, and thereby scores are calculated.

In step S54, smoothing of the scores, which are calculated in step S53, is performed. In the smoothing, an average of the outlier scores, which are calculated in steps S51 and S52, is calculated with respect to data whose width is within a window of T (predetermined integer). By shifting the window, a time series of moving-average scores is newly constituted.

The probability distribution function is learned in step S55, and the scores are calculated in step S56. The processes of steps S55 and S56 are collectively referred to as second-step learning. New time series data, which are smoothed in step S54 using the AR model, are modeled, and thereby the learning is performed again using the SDAR algorithm.

The obtained data of the stochastic model at each point of time are calculated using a logarithm loss, or using a Hellinger distance like steps S52 and S53, and thereby scores are calculated. The degree of change at each point of time becomes higher as the scores become higher.

An advantage of the change finder is as follows. In the first-step learning, only outliers in time series data are detected. However, after the outliers corresponding to a noise are removed by the smoothing of outlier scores, only an essential variation can be detected through the second learning.

In the first exemplary embodiment and a third exemplary embodiment, described later, of the present disclosure, predetermined integer T used in the description of step S54 is defined as “smooth.”

In performing the calculation sequentially, the SDAR algorithm updates a parameter or a statistical amount, which is required for the calculation, in a weighted average form, i.e., (1−r): r of a ratio of the present value and a new value. Herein, “r” is a forgetting parameter whose value is in a range of 0<r<1. The SDAR algorithm is more affected by the past data as “r” becomes smaller. In the first exemplary embodiment and the third exemplary embodiment, the forgetting parameter is also defined as “r.”

The scores, which are calculated in the first-step learning shown in FIG. 4, can also be used to detect a change in state of heating target 2. The scores calculated in the first-step learning are values before the smoothing of scores is performed. Therefore, the scores calculated in the first-step learning are effective in detecting a smaller change in state of heating target 2.

However, surrounding vibration and a change in dielectric constant of a wall surface of heating chamber 1, a door glass, or the like due to a temperature rise within heating chamber 1 are likely to be detected. Further, a noise due to a slight change in shape thereof is also likely to be detected. Therefore, according to its application, it is preferred to determine which of the scores calculated in the first-step learning and the scores calculated in the second-step learning should be used for detecting a change in state of heating target 2.

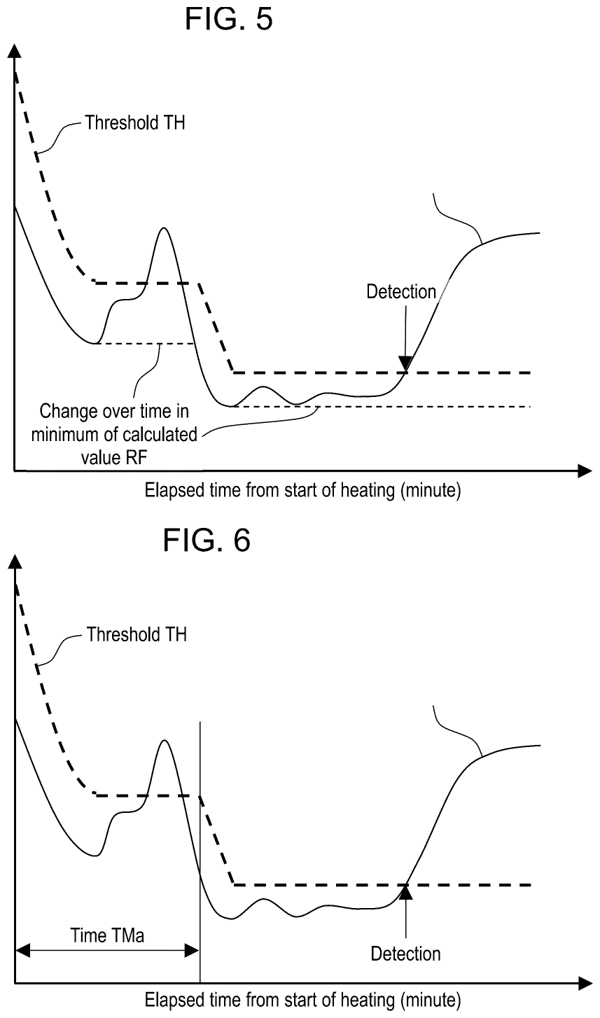

FIG. 5 is a view for explaining threshold TH used for detecting a change in state of heating target 2 in the first exemplary embodiment. Calculated value RF and threshold TH are shown on the graph of FIG. 5. In FIG. 5, the horizontal axis indicates elapsed time (minute) from the start of heating, and a vertical axis indicates calculated value RF.

A unit of the vertical axis in FIG. 5, i.e., the unit of calculated value RF and threshold TH is determined depending on which value is used as calculated value RF. For instance, if calculated value RF is an average of values of the reflected electric power, power (W) will be employed as the unit of the vertical axis in FIG. 5. Similarly, if calculated value RF is a standard deviation of values of the reflected electric power, power (W) will also be employed as the unit of the vertical axis. If calculated value RF is a value calculated by using a change finder method, a dimensionless quantity will be employed as the unit of the vertical axis in FIG. 5.

As mentioned above, threshold TH is a value more than one time and less than three times of the minimum of calculated value RF. There will be described a method in which threshold TH is determined based on calculated value RF from the start of heating.

Threshold TH is calculated by multiplying the minimum of calculated value RF from the start of heating by a predetermined magnification. In the present disclosure, the magnification is a value more than one time and less than three times. When the minimum of calculated value RF is updated, control unit 7 updates threshold TH by multiplying a new minimum value by the same magnification.

In other words, a minimum value among calculated values RF obtained from the reflected electric power that has been detected until that point is set as the minimum of calculated value RF. Therefore, as shown in FIG. 5, when calculated value RF decreases with a lapse of time, threshold TH decreases in response to the change. On the other hand, when calculated value RF increases with a lapse of time, threshold TH is not changed.

In the first exemplary embodiment, threshold TH for detection determination is not set in advance. With reference to the reflected electric power and the incident electric power stored in storage unit 8 (the first storage part of storage unit 8), control unit 7 determines threshold TH for each of heating targets whose weights, shapes, and containers are different. This makes it possible to perform flexible detection in which a variation of heating target 2 in actual cooking is taken into account. As a result, the possibility of erroneous detection can be reduced, thereby enabling high-accuracy detection.

When calculated value RF is reflectance, threshold TH is a value more than one time and less than three times of the minimum of reflectance. By using threshold TH, it is made possible to detect a slight change in state of a heating target such as melting at a very small portion of heating target 2 or partial boiling. As mentioned above, the reflectance is a ratio of a total sum of reflected electric power to a total sum of incident electric power.

The magnification by which the minimum of calculated value RF is multiplied also has an optimum value that changes depending on a weight, viscosity, a kind, and a container of heating target 2. Accordingly, storage unit 8 stores setting conditions suitable for a kind, weight, or the like of heating target 2 in advance. Based on information inputted by a user, such as a kind or weight of heating target 2, control unit 7 reads out optimum setting conditions from the storage unit 8 and uses them. Thus, the detection accuracy can be improved.

In the first exemplary embodiment and the third exemplary embodiment, the magnification by which the minimum of calculated value RF is multiplied is referred to as “threshold.”

FIG. 6 is a view for explaining detection of a change in state of heating target 2 in the first exemplary embodiment. In FIG. 6, a horizontal axis indicates elapsed time (minute) from the start of heating, and a vertical axis indicates calculated value RF. Calculated value RF and threshold TH are shown on the graph of FIG. 6. The units of the vertical axis and the horizontal axis in FIG. 6 are the same as in FIG. 5.

As shown in FIG. 6, even when calculated value RF exceeds threshold TH, control unit 7 does not determine the detection of a change in state of heating target 2 until predetermined time TMa (guard time) has elapsed from the start of heating. Calculated value RF, mentioned above, is obtained with reference to the reflected electric power.

Thus, the possibility of erroneous detection can be reduced in the following case, thereby enabling high-accuracy detection. The following case is the case where reflected electric power is instantaneously changed significantly due to a cause other than a phenomenon in which a change in state of heating target 2 occurs continuously, for example. Unstable operation of detecting unit 6 is also included in the following case.

The phenomena, other than a change in state of heating target 2, in which reflected electric power is instantaneously changed significantly include deformation of a wall surface of heating chamber 1, for example. The deformation is caused by expansion due to a temperature rise. Deformation of heating target 2 having an unstable shape is also included in one of the phenomena.

In a microwave oven serving as an example of the microwave processing device, these phenomena may often occur within 20 minutes after the start of heating. This is because it takes approximately 20 minutes until the temperature of heating chamber 1 reaches a setting temperature. Accordingly, in actual cooking, time TMa is suitable to be set in a range from 1 sec to 20 min.

The optimum value is changed depending on weight, viscosity, a kind, and a container of heating target 2. Accordingly, storage unit 8 stores setting conditions suitable for a kind, weight, or the like of heating target 2 in advance. Control unit 7 reads out the optimum setting conditions from storage unit 8 based on information inputted by a user, such as a kind or weight of heating target 2, and uses them. Thus, the detection accuracy can be improved.

<Boiling Detection>

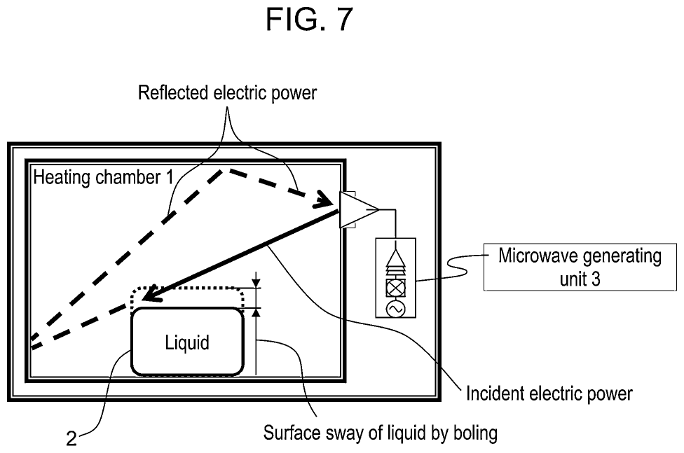

FIG. 7 is a conceptual diagram showing boiling detection of heating target 2 in the first exemplary embodiment. In FIG. 7, heating target 2 is a liquid.

As shown in FIG. 7, depending on surface sway of the boiling liquid, microwave may be absorbed in heating target 2, or sometimes may not be absorbed. Therefore, when the heating target is boiled, the reflected electric power varies dramatically. In other words, boiling of heating target 2 can be detected by calculating a change amount of reflected electric power.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency.

The frequency-averaged value is an average of a plurality of values of reflected electric power. The plurality of values of reflected electric power each are obtained for a corresponding one of a plurality of frequencies.

When the liquid is boiled, the value indicating a variation in a change amount of reflected electric power, such as variance, standard deviation, or a determination coefficient, becomes large. Therefore, by calculating the variation in a change amount of reflected electric power, the boiling of heating target 2 can be detected.

The variance may be sample variance, or may be unbiased variance. If the sample variance is used, the variation may be evaluated to be larger than necessary. For this reason, to evaluate a small variation, it may be more suitable to use a determination coefficient rather than sample variance.

The sample variance is defined by the following formula.

[Formula 1]

### Sampling Variance

When there are N single variable values yi (1=1,2, . . . ,N), if an average of the N values is y̅, sampling variance S_{yy} will be obtained by the following formula.

$${S}_{yy} = {\sum }_{i = 1}^{N} \frac{{( {y}_{i} - \overline{y} )}^{2}}{N}$$

### Covariance

When there are N binary variable values (xi, yi) (i=1,2, . . . ,N), if an average of x is x̅ and an average of y is y̅, k-covariance S_{xy} will be obtained by the following formula.

$${S}_{xy} = {\sum }_{i = 1}^{N} \frac{( {x}_{i} - \overline{x} ) ( {y}_{i} - \overline{y} )}{N}$$

Note that, the covariance is an average of values obtained by multiplying a deviation of one variable by a deviation of the other variable. The covariance indicates the tendency of a variation in the two variables.

The determination coefficient is defined by the following formula.

[Formula 2]

### Determination Coefficient

When there are N binary variable values (xi, yi) (i=1, 2, . . . ,N), determination coefficient R² is obtained by the following formula.

$${R}^{2} = \frac{{{S}_{xy}}^{2}}{{S}_{xx} {S}_{yy}} = \frac{{\{ {\sum }_{i = 1}^{N} \frac{( {x}_{i} - \overline{x} ) ( {y}_{i} - \overline{y} )}{N} \}}^{2}}{{\sum }_{i = 1}^{N} \frac{{( {x}_{i} - \overline{x} )}^{2}}{N} {\sum }_{i = 1}^{N} \frac{{( {y}_{i} - \overline{y} )}^{2}}{N}}$$

By detecting the boiling of heating target 2, control unit 7 can change heating conditions, or complete the heating. This can prevent overheating or underheating. As a result, cooking can be finished optimally.

Some cooking, like pot-au-feu, needs to heat foods within heating target 2 sufficiently by boiling them continuously for a certain period of time. In such cooking, duty control can be applied to an output of the microwave to maintain a weak boiling state after the boiling is detected. This makes it possible to reduce collapse of foods and turbidity of soup by overheating.

The duty control is a control method of outputting a fixed-level signal repeatedly while adjusting a ratio of ON and OFF.

As cooking required for the duty control of an output of the microwave after the boiling detection, cooking of soup such as pot-au-feu and a stew, and heating of drinks such as milk and water are included, for example.

<Demonstration Experiment of Boiling Detection>

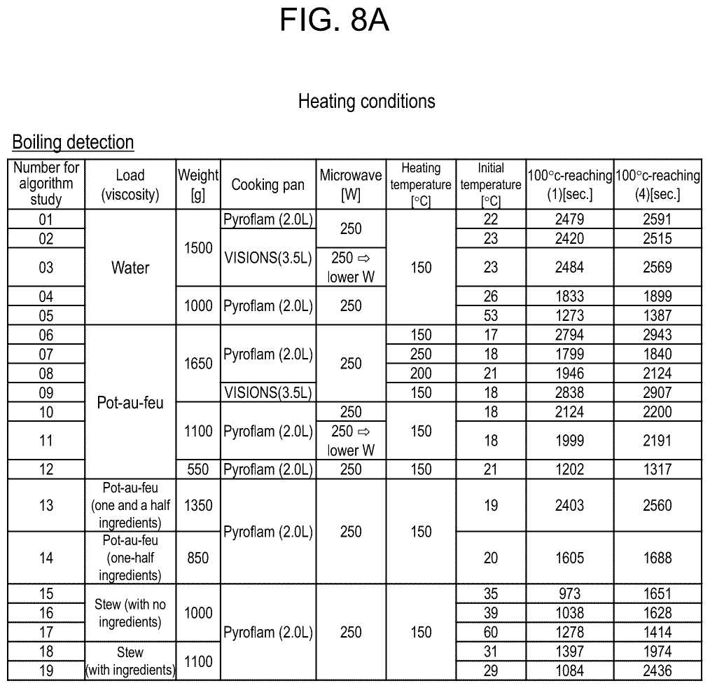

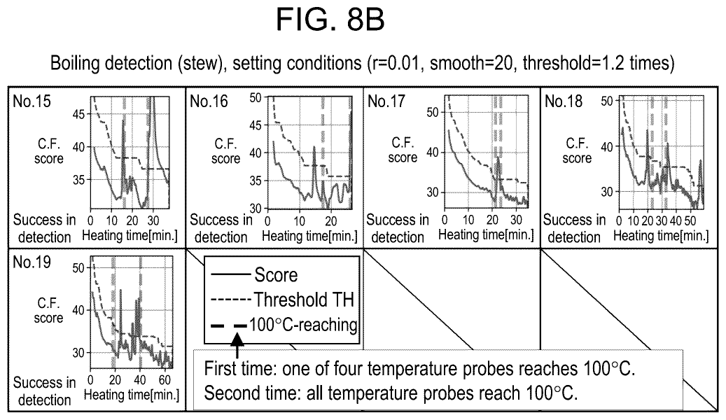

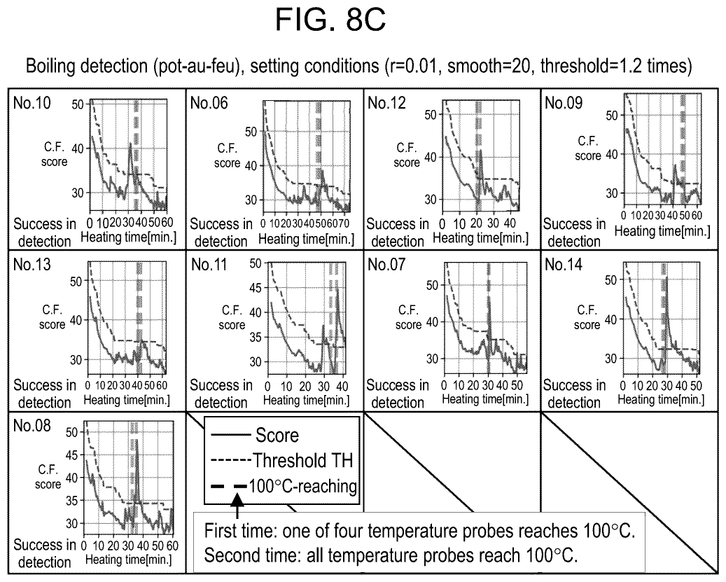

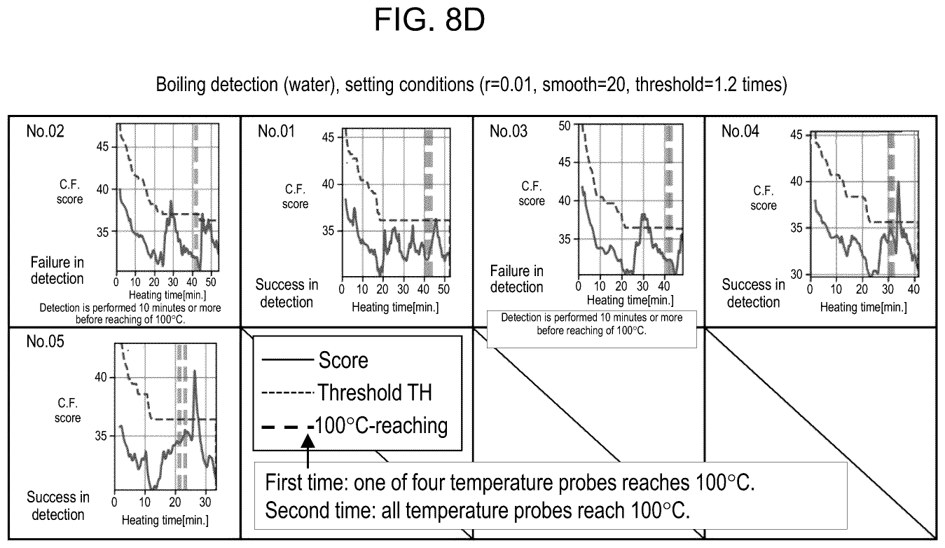

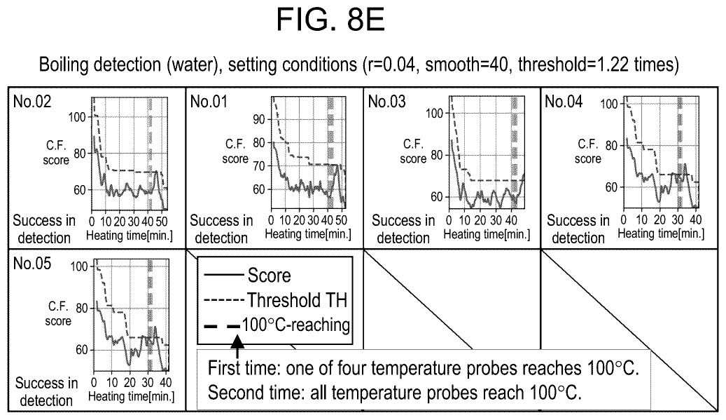

FIGS. 8A through 8E are views showing experimental results of the boiling detection in the first exemplary embodiment. FIG. 8A shows heating conditions in a demonstration experiment in which boiling of water, pot-au-feu, or a stew is detected.

In FIGS. 8B through 8E, a horizontal axis indicates heating time (minute), and a vertical axis indicates a score of a change finder. Each graph in FIGS. 8B through 8E shows a change over time in the score of the change finder and a change over time in threshold TH. Each graph further shows a point of time when one of four fiber-optic thermometer probes detects 100° C., and a point of time when all of those detect 100° C. The four fiber-optic thermometer probes are inserted into heating target 2.

FIG. 8B shows experimental results when the boiling of a stew is detected under setting conditions of the change finder, i.e., “r”=0.01, “smooth”=20, and “threshold”=1.2. As shown in FIG. 8B, as for the setting conditions, the boiling detection of a stew has succeeded under all of five heating conditions in which weight, a container, and the like are different.

FIG. 8C shows experimental results when the boiling of pot-au-feu is detected under setting conditions of the change finder, i.e., “r”=0.01, “smooth”=20, and “threshold”=1.2. As shown in FIG. 8C, as for the setting conditions, the boiling detection of pot-au-feu has succeeded under all of nine heating conditions in which weight, a container, and the like are different.

FIG. 8D shows experimental results when the boiling of water is detected under setting conditions of the change finder, i.e., “r”=0.01, “smooth”=20, and “threshold”=1.2. As shown in FIG. 8D, as for the setting conditions, the boiling detection of water has succeeded under three heating conditions among five heating conditions in which weight, a container, and the like are different.

FIG. 8E shows experimental results when the boiling of water is detected under setting conditions of the change finder, i.e., “r”=0.04, “smooth”=40, and “threshold”=1.22. As shown in FIG. 8E, as for the setting conditions, the boiling detection of water has succeeded under all of five heating conditions in which weight, a container, and the like are different.

As mentioned above, the setting conditions of the change finder, which have been used in the boiling detection of a stew and pot-au-feu, are used in the boiling detection of water. For this reason, the boiling detection of water has failed under some heating conditions. However, if setting conditions of the change finder suitable for the boiling detection of water are used, the boiling detection of water will be made possible under all of the heating conditions.

By using the setting conditions of the change finder, even if weight, viscosity, a kind, and a container of heating target 2 and a ratio of water and an ingredient are different, a change in state of heating target 2 will be made detectable.

Depending on the setting conditions, the score, which is to be calculated, differs significantly. Accordingly, storage unit 8 stores setting conditions suitable for a kind, weight, or the like of heating target 2 in advance. Control unit 7 reads out the optimum setting conditions based on information inputted by a user, such as a kind or weight of heating target 2, from storage unit 8 and uses them. Thus, the detection accuracy can be improved.

In the demonstration experiments shown in FIGS. 8A through 8E, cooking is performed with a glass container covered with a lid. However, the same result can be obtained even when the lid is removed.

If a metal container, which does not pass microwave therethrough, is covered with a metal lid, a vapor will be emitted into the heating chamber from between the container and the lid by boiling. Further, the vapor condenses and waterdrop adheres in heating chamber 1. Thus, calculated value RF, which is obtained with reference to the reflected electric power, is changed significantly. Consequently, the boiling of heating target 2 can be detected.

In the demonstration experiments shown in FIGS. 8A through 8E, by adding consomme granules or a commercially available solid roux for a stew, a dielectric constant of heating target 2 is increased, so that viscosity thereof is also changed. However, even if the dielectric constant and the viscosity are changed due to a cause other than consomme and a solid roux. the boiling can be detected.

As mentioned above, the first exemplary embodiment can detect the boiling of heating target 2 of which weight, a shape, a material, a placing position, and the like are different, thereby making it possible to finish cooking optimally.

### Second Exemplary Embodiment

<Entire Configuration>

A microwave processing device in a second exemplary embodiment of the present disclosure is provided with the same configuration as that of the microwave processing device in the first exemplary embodiment shown in FIG. 1. Accordingly, in the second exemplary embodiment, like reference signs indicate like elements of the first exemplary embodiment, and overlapping descriptions thereof are omitted.

In the second exemplary embodiment, the calculation, which is performed with reference to the reflected electric power stored in storage unit 8 (the first storage part of storage unit 8), is performed for each of frequencies of the microwave by control unit 7. When calculated values RF obtained for two or more frequencies of the microwave exceed threshold TH, control unit 7 determines that a change in state of heating target 2 is detected.

In the second exemplary embodiment, control unit 7 causes storage unit 8 (the first storage part of storage unit 8) to store a value of incident electric power and a value of reflected electric power, together with a frequency of the microwave and an elapsed time from the start of heating. Control unit 7 calculates reflectance from the incident electric power and the reflected electric power, which are stored in storage unit 8, and controls microwave generating unit 3 based on the reflectance. As mentioned above, the reflectance is a ratio of a total sum of reflected electric power to a total sum of incident electric power.

When calculated value RF exceeds threshold TH a plurality of times during an optional period of time, control unit 7 further controls microwave generating unit 3. Herein, calculated value RF is obtained with reference to the reflected electric power stored in storage unit 8 (the first storage part of storage unit 8).

In the second exemplary embodiment, control unit 7 detects expansion of heating target 2 in heating chamber 1 as a change in state of heating target 2.

In the second exemplary embodiment, the microwave processing device includes a radiation heater and a steam generator (both are not shown) as a heating unit, in addition to microwave generating unit 3. However, the heating unit may include the radiation heater and/or the steam generator, but it is not necessary to include both.

After the expansion of heating target 2 is detected, control unit 7 changes heating conditions, which include a change of the heating unit to be used. The change of the heating unit to be used means that the heating unit to be used is changed to the radiation heater or the steam generator from microwave generating unit 3 in the heating processing, or vice versa, for example.

<Flowchart>

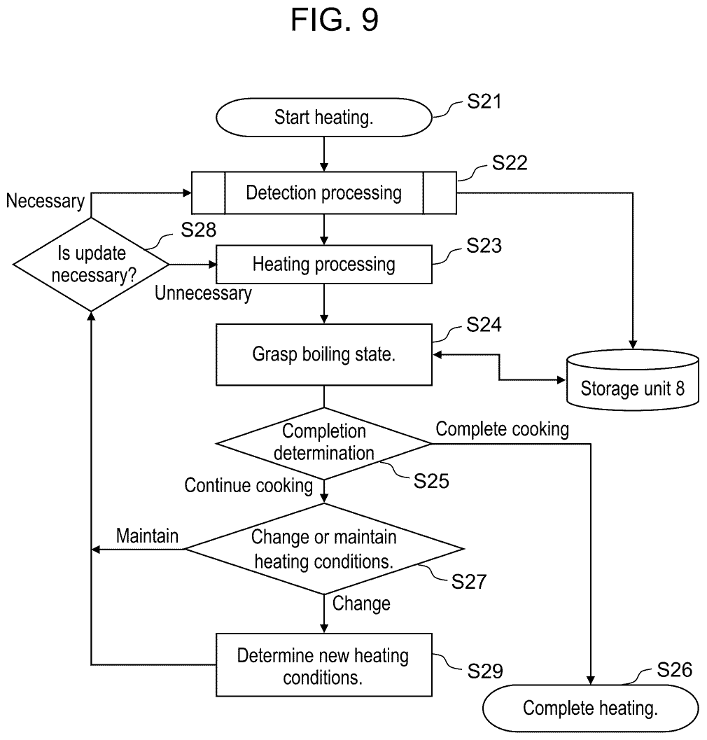

FIG. 9 is a flowchart showing a flow of the entire cooking control in the second exemplary embodiment. As shown in FIG. 9, when control unit 7 controls microwave generating unit 3 to start heating (step S21), control unit 7 performs detection processing (step S22) of reflected electric power, firstly.

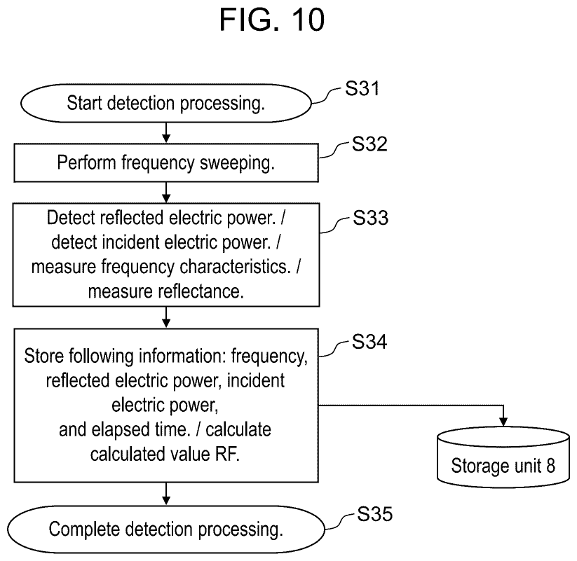

FIG. 10 is a flowchart showing details of the detection processing. As shown in FIG. 10, when the detection processing is started (step S31), microwave generating unit 3 performs frequency sweeping (step S32).

Detecting unit 6 detects reflected electric power and incident electric power for each of frequencies of the microwave during the frequency sweeping. Control unit 7 measures frequency characteristics of the reflected electric power, frequency characteristics of the incident electric power, and reflectance from the reflected electric power and the incident electric power that have been detected (step S33).

Control unit 7 causes storage unit 8 (the first storage part of storage unit 8) to store each frequency in the frequency sweeping, and the reflected electric power, the incident electric power, and the reflectance for each frequency that are obtained in the measurement processing. Control unit 7 also causes storage unit 8 (the first storage part of storage unit 8) to store an elapsed time from the start of heating (step S34). Control unit 7 calculates calculated value RF, which is to be used for the expansion detection, based on the two obtained frequency characteristics (step S34), and completes the detection processing (step S35).

Returning the processing to the flowchart shown in FIG. 9, control unit 7 starts heating of heating target 2 by microwave heating (step S23) in the heating processing. In the heating processing, control unit 7 may use oven heating or radiation heating by using the radiation heater, or steam heating by the steam generator, in addition to the microwave heating.

Control unit 7 grasps an expansion state of heating target 2 from the information obtained in the detection processing (step S24). In completion determination (step S25), control unit 7 determines whether heating target 2 is in the expansion state or not.

When determining that heating target 2 is in the expansion state, control unit 7 completes the cooking (step S26). Otherwise, according to the expansion state of heating target 2, control unit 7 determines whether to maintain the same heating conditions, or change heating conditions (step S27). Herein, the heating conditions include a change of the heating unit to be used.

When determining to maintain the same heating conditions, control unit 7 proceeds the processing to step S28. In step S28, when a certain period of time has elapsed from the start of heating, or when the heating conditions are changed or the like, control unit 7 determines whether an update of frequency characteristics is necessary or not. If the update is necessary, control unit 7 will return the processing to the detection processing (step S22). Alternatively, if the update is unnecessary, control unit 7 will return the processing to the heating processing (step S23).

In step S27, when determining that a change of the heating conditions is necessary, control unit 7 determines new heating conditions, which include a change of the heating unit to be used or the like (step S29), and proceeds the processing to step S28.

In the frequency sweeping, microwave generating unit 3 generates microwave while increasing the frequency at predetermined frequency intervals from the minimum of a predetermined frequency band in sequence. Control unit 7 measures frequency characteristics of the reflectance, and selects a frequency at which the reflectance becomes lowest based on the obtained frequency characteristics.

However, a method of selecting the frequency at which the reflectance becomes lowest is not limited to this. For instance, microwave generating unit 3 may generate microwave while changing the frequency randomly in a predetermined frequency band. Control unit 7 may calculate reflectance for each frequency to select the frequency at which the reflectance becomes lowest.

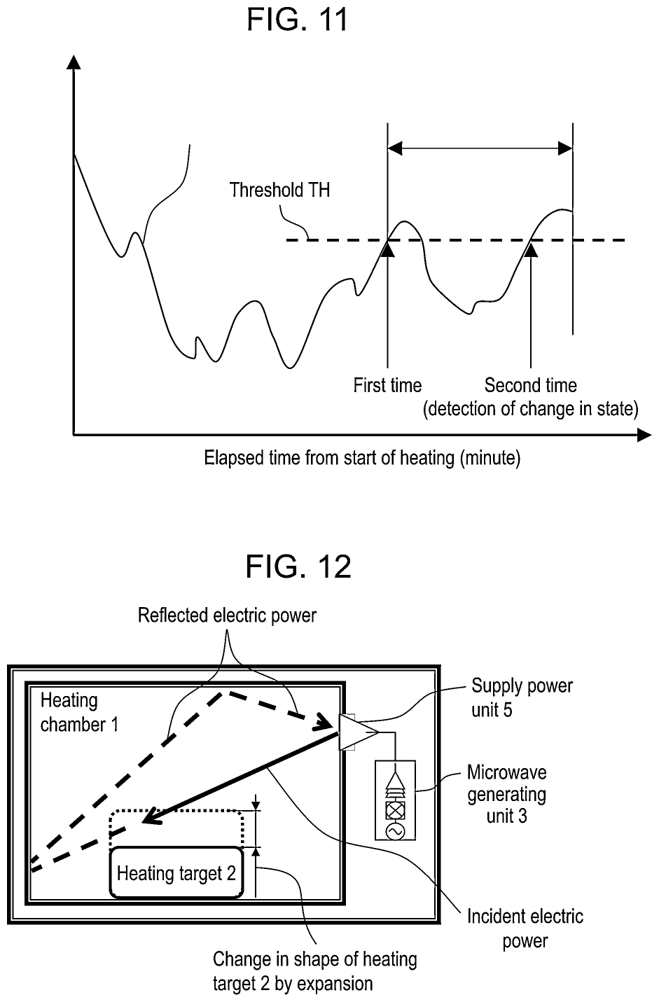

FIG. 11 is a view for explaining detection of a change in state of heating target 2 in the second exemplary embodiment.

In FIG. 11, a horizontal axis indicates elapsed time (minute) from the start of heating, and a vertical axis indicates calculated value RF obtained with reference to the reflected electric power stored in storage unit 8 (the first storage part of storage unit 8). Calculated value RF and threshold TH are shown on the graph of FIG. 11. Units of the vertical axis and the horizontal axis in FIG. 11 are the same as in FIG. 5.

As shown in FIG. 11, when calculated value RF, which is obtained with reference to the reflected electric power, exceeds threshold TH twice during predetermined time TMb, control unit 7 determines that a change in state of heating target 2 occurs.

Thus, the possibility of erroneous detection can be reduced in the following case, thereby enabling high-accuracy detection. The following case is the case where the reflected electric power is instantaneously changed significantly due to a cause other than a phenomenon in which a change in state of heating target 2 occurs continuously, for example. Unstable operation of detecting unit 6 is also included in that case.

The phenomena, other than a change in state of heating target 2, in which the reflected electric power is instantaneously changed significantly include deformation of a wall surface of heating chamber 1, for example. The deformation is caused by expansion due to a temperature rise. Deformation of heating target 2 having an unstable shape is also included in one of the phenomena.

In actual cooking, predetermined time TMb is preferred to be set in one second or more. This is because the above-mentioned phenomena rarely continue to occur for one second or more. Further, as mentioned above, when calculated value RF exceeds threshold TH a plurality of times during predetermined time TMb, a change in state of heating target 2 is determined to occur, thereby improving the detection accuracy. Practically, the number of the plurality of times is preferred to be set in a range from 2 to 10.

<Expansion Detection>

FIG. 12 is a conceptual diagram showing expansion detection of heating target 2 in the second exemplary embodiment. As shown in FIG. 12, the shape of heating target 2 is changed by the expansion of heating target 2, and heating target 2 is dried.

With this, a dielectric constant of entire heating target 2 is changed, and a distribution of the dielectric constant in the heating target 2 is also changed. Thus, frequency characteristics of absorbed electric power are also changed. As a result, by calculating a change amount of the reflected electric power during heating of heating target 2, the expansion of heating target 2 can be detected. The absorbed electric power means microwave absorbed in heating target 2.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency. Generally, when heating target 2 is dried, the dielectric constant decreases.

By detecting whether the expansion of heating target 2 is started or completed, control unit 7 can determine whether to change heating conditions or complete the heating. This can prevent overheating or underheating. As a result, cooking can be finished optimally.

As the cooking in which the expansion detection is used, baking of a material (puff pastry) of a souffle and a cream puff, and baking of baked goods are included, for example.

As mentioned above, according to the second exemplary embodiment, accurate expansion detection is made possible for heating target 2 of which weight, a shape, a material, a placing position, and the like are different, so that the cooking can be finished optimally.

### Third Exemplary Embodiment

<Entire Configuration>

A microwave processing device in a third exemplary embodiment of the present disclosure is provided with the same configuration as that of the microwave processing device in the first exemplary embodiment shown in FIG. 1. Accordingly, in the third exemplary embodiment, like reference signs indicate like elements of the first exemplary embodiment, and overlapping descriptions thereof are omitted.

In the third exemplary embodiment, control unit 7 detects melting of heating target 2 in heating chamber 1 as a change in state of heating target 2.

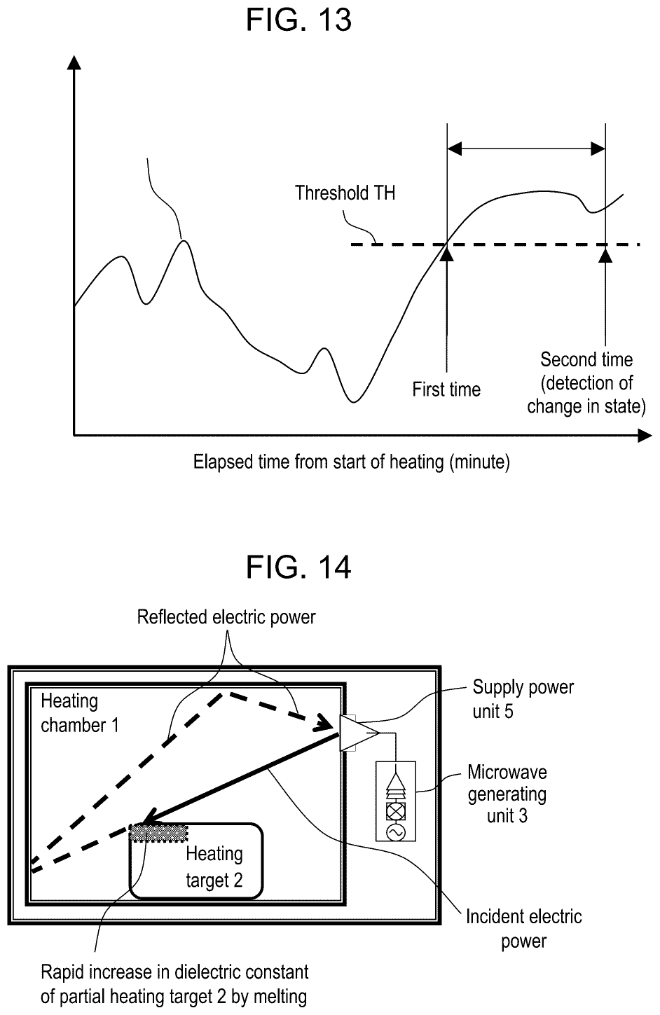

FIG. 13 is a view for explaining detection of a change in state of heating target 2 in the third exemplary embodiment.

In FIG. 13, a horizontal axis indicates elapsed time (minute) from the start of heating, and a vertical axis indicates calculated value RF obtained with reference to the reflected electric power stored in storage unit 8 (the first storage part of storage unit 8). Calculated value RF and threshold TH are shown on the graph of FIG. 13. Units of the vertical axis and the horizontal axis in FIG. 13 are the same as in FIG. 5.

As shown in FIG. 13, when calculated value RF, which is obtained with reference to the reflected electric power, exceeds threshold TH continuously during predetermined time TMc, control unit 7 determines that a change in state of heating target 2 is detected.

Thus, the possibility of erroneous detection can be reduced in the following case, thereby enabling high-accuracy detection. The following case is the case where the reflected electric power is instantaneously changed significantly due to a cause other than a phenomenon in which a change in state of heating target 2 occurs continuously, for example. Unstable operation of detecting unit 6 is also included in that case.

The phenomena, other than a change in state of heating target 2, in which the reflected electric power is instantaneously changed significantly include deformation of a wall surface of heating chamber 1, for example. The deformation is caused by expansion due to a temperature rise. Deformation of heating target 2 having an unstable shape is also included in one of the phenomena.

In actual cooking, predetermined time TMc is preferred to be set in one second or more. This is because the above-mentioned phenomena rarely continue to occur for one second or more.

<Melting Detection>

FIG. 14 is a conceptual diagram showing melting detection of heating target 2 in the third exemplary embodiment. As shown in FIG. 14, heating target 2 is deformed by melting.

With this, a dielectric constant of entire heating target 2 is changed, and a distribution of the dielectric constant in the heating target 2 is also changed. Thus, frequency characteristics of absorbed electric power are changed. As a result, by calculating a change amount of the reflected electric power during heating of heating target 2, the melting of heating target 2 can be detected.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency. Generally, when heating target 2 is melted, the dielectric constant increases.

By detecting whether the melting of heating target 2 is started or completed, control unit 7 can determine whether to change heating conditions or complete the heating. This can prevent overheating or underheating. As a result, cooking can be finished optimally.

As the cooking in which the melting detection is used, melting of butter and chocolate is included, for example.

<Demonstration Experiment of Melting Detection>

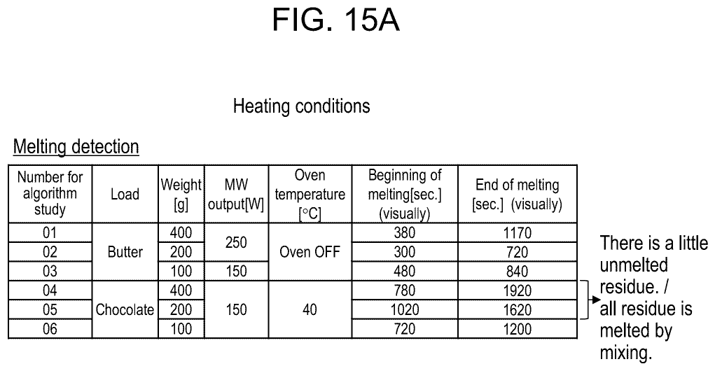

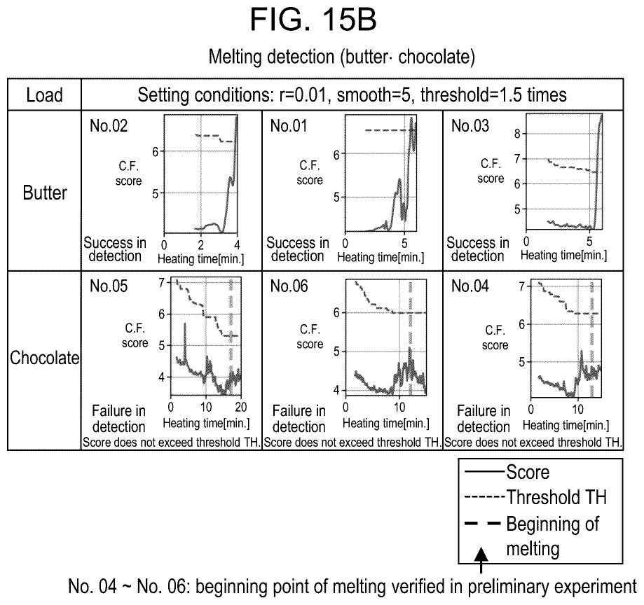

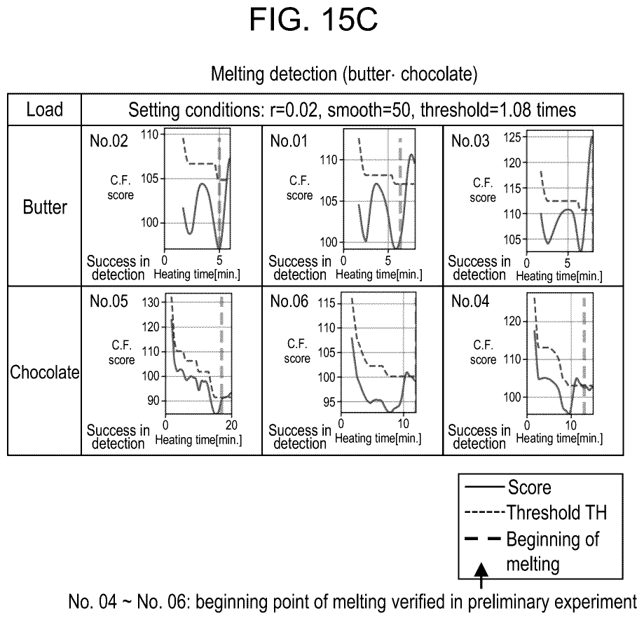

FIGS. 15A through 15C are views showing experimental results of melting detection in the third exemplary embodiment. FIG. 15A shows heating conditions of butter and chocolate in a demonstration experiment of the melting detection.

In FIGS. 15B and 15C, the horizontal axis indicates heating time (minute), and the vertical axis indicates a score of a change finder. Each graph in FIGS. 15B and 15C shows the score of the change finder, threshold TH, and the time when heating target 2 begins to melt.

FIG. 15B shows experimental results of melting detection of butter and chocolate under setting conditions of the change finder, i.e., “r”=0.01, “smooth”=5, and “threshold”=1.5. As shown in FIG. 15B, under these setting conditions, the melting detection of butter has succeeded, but the melting detection of chocolate has failed.

FIG. 15C shows experimental results of melting detection of butter and chocolate under setting conditions of the change finder, i.e., “r”=0.02, “smooth”=50, and “threshold”=1.08. As shown in FIG. 15C, under these setting conditions, the melting detection of butter and the melting detection of chocolate both have succeeded.

By using the setting conditions of the change finder, even if weight and a kind of heating target 2 are different, a change in state of heating target 2 can be detected.

Depending on the setting conditions, the score to be calculated differs significantly. Accordingly, storage unit 8 stores setting conditions suitable for a kind, weight, or the like of heating target 2 in advance. Control unit 7 reads out the optimum setting conditions based on information inputted by a user, such as a kind or weight of heating target 2, from storage unit 8 and uses them. Thus, the detection accuracy can be improved.

As mentioned above, according to the third exemplary embodiment, accurate melting detection is made possible for heating target 2 of which weight, a shape, a material, a placing position, and the like are different, so that the cooking can be finished optimally.

### Fourth Exemplary Embodiment

<Entire Configuration>

A microwave processing device in a fourth exemplary embodiment of the present disclosure is provided with the same configuration as that of the microwave processing device in the first exemplary embodiment shown in FIG. 1. Accordingly, in the fourth exemplary embodiment, like reference signs indicate like elements of the first exemplary embodiment, and overlapping descriptions thereof are omitted. In the fourth exemplary embodiment, control unit 7 detects defrosting of heating target 2 as a change in state of heating target 2.

<Defrosting Detection>

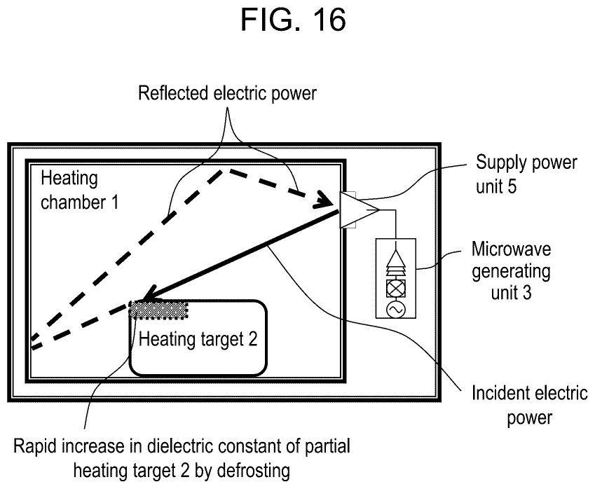

FIG. 16 is a conceptual diagram showing defrosting detection of heating target 2 in the fourth exemplary embodiment. As shown in FIG. 16, heating target 2 is deformed by defrosting.

With this, a dielectric constant of entire heating target 2 is changed, and a distribution of the dielectric constant in the heating target 2 is also changed. Thus, frequency characteristics of absorbed electric power are changed. As a result, by calculating a change amount of the reflected electric power during heating of heating target 2, the defrosting of heating target 2 can be detected.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency. Generally, when heating target 2 is defrosted, the dielectric constant increases.

By detecting whether the defrosting of heating target 2 is started or completed, control unit 7 can determine whether to change heating conditions or complete the heating. This can prevent overheating or underheating. As a result, the cooking can be finished optimally.

As the cooking in which the defrosting detection is used, defrosting of frozen meat, frozen fish, frozen vegetables, and ice is included, for example.

As mentioned above, according to the fourth exemplary embodiment, accurate defrosting detection is made possible for heating target 2 of which weight, a shape, a material, a placing position, and the like are different, so that the cooking can be finished optimally.

### Fifth Exemplary Embodiment

A microwave processing device in a fifth exemplary embodiment of the present disclosure is provided with the same configuration as that of the microwave processing device in the first exemplary embodiment shown in FIG. 1. Accordingly, in the fifth exemplary embodiment, like reference signs indicate like elements of the first exemplary embodiment, and overlapping descriptions thereof are omitted. In the fifth exemplary embodiment, the control unit 7 detects a burst of heating target 2 as a change in state of heating target 2.

<Burst Detection>

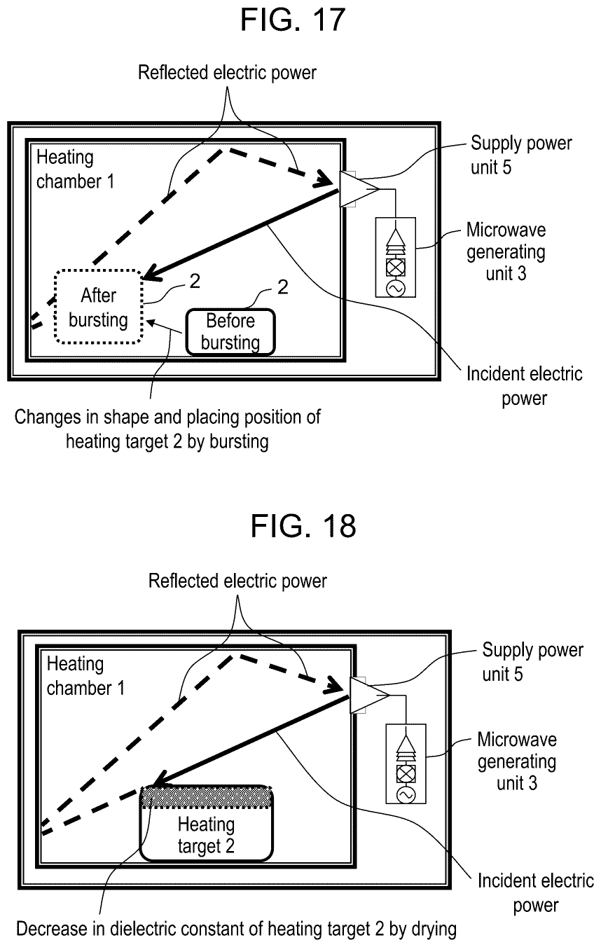

FIG. 17 is a conceptual diagram showing burst detection of heating target 2 in the fifth exemplary embodiment. As shown in FIG. 17, a shape of heating target 2 and a placing position of heating target 2 in heating chamber 1 are changed by a burst. With this change, frequency characteristics of absorbed electric power are changed. As a result, by calculating a change amount of the reflected electric power during heating of heating target 2, the burst of heating target 2 can be detected.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency.

By detecting the burst of heating target 2, control unit 7 can determine whether to change heating conditions or complete the heating. This can prevent overheating or underheating. As a result, the cooking can be finished optimally.

As the cooking in which the burst detection is used, making of popcorn is included, for example.

As mentioned above, according to the fifth exemplary embodiment, accurate burst detection is made possible for heating target 2 of which weight, a shape, a material, a placing position, and the like are different, so that the cooking can be finished optimally.

### Sixth Exemplary Embodiment

A microwave processing device in a sixth exemplary embodiment of the present disclosure is provided with the same configuration as that of the microwave processing device in the first exemplary embodiment shown in FIG. 1. Accordingly, in the sixth exemplary embodiment, like reference signs indicate like elements of the first exemplary embodiment, and overlapping descriptions thereof are omitted. In the sixth exemplary embodiment 6, control unit 7 detects drying of heating target 2 as a change in state of heating target 2.

<Drying Detection>

FIG. 18 is a conceptual diagram showing drying detection of heating target 2 in the sixth exemplary embodiment. As shown in FIG. 18, heating target 2 is deformed by drying.

With this, a dielectric constant of entire heating target 2 is changed, and a distribution of the dielectric constant in the heating target 2 is also changed. Thus, frequency characteristics of absorbed electric power are changed. As a result, by calculating a change amount of the reflected electric power during heating of heating target 2, the drying of heating target 2 can be detected.

The value, which indicates the change amount of reflected electric power, includes standard deviation, variance, and a determination coefficient of values of reflected electric power per any time, the score calculated by using a change finder method, or a change rate and a change width of reflected electric power per any time. The value, which indicates the change amount of reflected electric power, further includes a frequency-averaged value of reflected electric power and a value of reflected electric power for every frequency. Generally, when heating target 2 is dried, the dielectric constant decreases.

By detecting whether the drying of heating target 2 is started or completed, control unit 7 can determine whether to change heating conditions or complete the heating. This can prevent overheating or underheating. As a result, the cooking can be finished optimally.

As the cooking in which the drying detection is used, making of dried fruit, dried vegetables, and dried meat is included, for example. The drying detection can also be used for decreasing excessive moisture in foods. As application of the drying detection other than cooking, drying of wood, clothes, or the like by microwave is included.

As mentioned above, according to the sixth exemplary embodiment, accurate drying detection is made possible for heating target 2 of which weight, a shape, a material, a placing position, and the like are different, so that the cooking can be finished optimally.

### INDUSTRIAL APPLICABILITY

Besides the heating cooker for heating foods dielectrically, the microwave processing device in accordance with the present disclosure is applicable to a microwave heating device for industrial use such as drying equipment, a heating device for ceramic art, a garbage disposal machine, a semiconductor fabrication device, and a chemical reaction device.

### REFERENCE MARKS IN THE DRAWINGS

1 heating chamber
2 heating target
3 microwave generating unit
4 amplifying unit
5 power supply unit
6 detecting unit
7 control unit
8 storage unit

1. A microwave processing device comprising:
a heating chamber that is configured to accommodate a heating target;
a heating unit that includes a microwave generating unit configured to generate microwave having an optional frequency in a predetermined frequency band;
an amplifying unit that is configured to amplify an output level of the microwave;
a power supply unit that is configured to radiate the microwave amplified by the amplifying unit into the heating chamber as incident electric power;
a detecting unit that is configured to detect reflected electric power from among the incident electric power, the reflected electric power returning to the power supply unit from the heating chamber;
a control unit that controls the microwave generating unit and the amplifying unit; and
a storage unit that is configured to store a value of the reflected electric power, together with a frequency of the microwave and an elapsed time from a start of heating,
wherein
the control unit is configured to control the microwave generating unit and the amplifying unit based on a calculated value obtained by calculation with reference to the reflected electric power.

2. The microwave processing device according to claim 1, wherein
the control unit is configured to use an average of values calculated for every frequency of the microwave as the calculated value.

3. The microwave processing device according to claim 1, wherein
the control unit calculates the calculated value for every frequency of the microwave, and
the control unit is configured to control the microwave generating unit, when the calculated values for two or more frequencies of the microwave exceed a threshold.

4. The microwave processing device according to claim 1, wherein
the control unit is configured to calculate the calculated value using a change finder serving as an online change-point detection method for time series data.

5. The microwave processing device according to claim 1, wherein:
the detecting unit is further configured to detect the incident electric power;
the storage unit is configured to store a value of the incident electric power, together with the frequency of the microwave and the elapsed time;
the control unit calculates reflectance as the calculated value, the reflectance being a ratio of a total sum of the reflected electric power to a total sum of the incident electric power; and
the control unit is configured to control the microwave generating unit based on the reflectance.

6. The microwave processing device according to claim 1, wherein
the control unit causes the storage unit to store the calculated value together with the elapsed time, and
the control unit is configured to control the microwave generating unit, when the calculated value exceeds a threshold that is more than one time and less than three times of a minimum of the calculated value.

7. The microwave processing device according to claim 6, wherein
the control unit is configured so as not to control the microwave generating unit until a predetermined time has elapsed from the start of heating, even if the calculated value exceeds the threshold.

8. The microwave processing device according to claim 6, wherein
the control unit is configured to control the microwave generating unit, when the calculated value exceeds the threshold a plurality of times within a predetermined period of time.

9. The microwave processing device according to claim 6, wherein
the control unit is configured to control the microwave generating unit, when the calculated value exceeds the threshold continuously within a predetermined period of time.

10. The microwave processing device according to claim 1, wherein
the control unit is configured to detect boiling of the heating target as a change in state of the heating target.

11. The microwave processing device according to claim 1, wherein
the control unit is configured to detect expansion of the heating target as a change in state of the heating target.

12. The microwave processing device according to claim 1, wherein
the control unit is configured to detect melting of the heating target as a change in state of the heating target.

13. The microwave processing device according to claim 1, wherein
the control unit is configured to detect defrosting of the heating target as a change in state of the heating target.

14. The microwave processing device according to claim 1, wherein
the control unit is configured to detect a burst of the heating target as a change in state of the heating target.

15. The microwave processing device according to claim 1, wherein
the control unit is configured to detect drying of the heating target as a change in state of the heating target.

16. The microwave processing device according to claim 10, wherein
the control unit is configured to stop heating after the change in state of the heating target is detected.

17. The microwave processing device according to claim 10, wherein
the control unit is configured to change heating conditions after the change in state of the heating target is detected.
